(19) United States
(12) Patent Application Publication
(10) Pub. No.: US 2013/0268335 A1
(43) Pub. Date: Oct. 10, 2013

(54) Media Based Coupon Distribution System

(71) Applicants: Robin Ross Cooper, La Mesa, CA (US); Michael R. Beatty, San Diego, CA (US); Robert T. Kulakowski, Rancho Santa Fe, CA (US)

(72) Inventors: Robin Ross Cooper, La Mesa, CA (US); Michael R. Beatty, San Diego, CA (US); Robert T. Kulakowski, Rancho Santa Fe, CA (US)

(21) Appl. No.: 13/860,502

(22) Filed: Apr. 10, 2013

Related U.S. Application Data
(60) Provisional application No. 61/622,473, filed on Apr. 10, 2012.

(51) Int. Cl. G06Q 30/02

(52) U.S. Cl. CPC G06Q 30/0217
USPC 705/14.19

(57) ABSTRACT

A digital coupon system for electronically distributing coupons and inducements to viewers over broadcast media. The system employs a viewable or audible signal to indicate to viewers the availability of a coupon or inducement during real time viewing using an image animation overlaid onto displayed ad or program content. Coupon inducements and delivery can be based on coupon business rules defining requirements for delivery. The system is especially well configured to encourage the viewing of broadcast media commercials which are frequently skipped over by viewers.

This application is a non-provisional of U.S. Provisional Application Ser. No. 61/622,473 filed on Apr. 10, 2012 which is claiming priority and is included herein in its entirety by this reference thereto.

### BACKGROUND OF THE INVENTION

1. Field of the Invention

The present invention relates to coupons distributed for goods and services. More particularly it relates to a system for distribution of coupons which employs image animation as a user-viewable signal, concurrent with media displayed on a video screen such as an ad or program content which encourages viewers not to skip through the commercial ad. The depiction on video display provides viewing users an ability to discern a current coupon availability, and act on such to receive such or discounts. The coupons or discounts may be user-customized to a respective user's demographic profile in a database which is cross referenced with the location of their media playing device, and then delivered electronically or otherwise.

2. Prior Art

Coupons and discount offers have been distributed for decades to current and potential customers for products and services. Such coupons or discount offers conventionally offer the holder a discount on a particular product or service, or free or discounted products or services which may be provided in conjunction when other products or services ordered. There is no limit to the imagination product sellers and coupon distributors have placed into such coupons to entice buyers to spend for a particular product or service.

However, until recently, most coupons were printed and sent by mail, or printed in newspapers and periodicals, which are distributed to potential customers for the products and services. A large body of research exists on what publications or zip codes should be employed to reach potential buyers having demographic backgrounds deemed compatible for the coupons placed for their finding.

Printed coupons in the last decade, have made way for digitally distributed coupons. Such coupons are sent via email, or downloaded from webpages, or may be attached to text messages, or are made available to consumers in a wide variety of ways. With the advent of computers and databases on such consumers, such as the grocery store “club cards” and warranty registrations for products, and a plethora of other databases which consumers provide personal information, a large body of digital information exists on consumers identities, locations, communication means, and their preferences for products and services. Consequently, such digital consumer files are being employed more often to target particular buyers for products and services believed to be attractive to such particular consumers. Using this targeting information, it has become common for coupons to be “pushed” electronically to targeted customers and consumers using their demographic profile in relation to coupons for a particular product or service which appear to be attractive to the respective targeted customer. Thus, potential customers are delivered digitally, coupons and coupon offers based on their known demographic profile as it is related to the coupon being offered for the specific product and service.

However, with the advent of “spam” type email and other digital communications, many consumers have filtered out digital communications to their smartphone or computer as unwanted communications from unknown senders. This has become a problem for marketers to reach their intended buyers, and, has become a problem for buyers who frequently miss a valuable coupon or offer sent to them digitally due to filtering of digital communications they have requested.

As a consequence, there exists a need for a new digital coupon delivery system which enables the consumer to opt to receive a “pushed” or conventional advertisement or offer which includes a coupon, in real time. Such a system should be employable in combination with media and programming a consumer or customer may be voluntarily viewing, so as to allow the coupon offer to actually reach the intended targeted buyer or consumer so they have a chance to actually receive coupons for goods and services they readily buy or may want based on their demographic profile.

Further, such a system should be enabled with real time signaling to encourage viewers or users, to watch advertising rather than skipping through it on recorded programs, to allow broadcasters to insure to advertisers that viewers will watch the commercials being purchased. Additionally, such a system while making an offer or coupon know to particular consumers, or untargeted consumers, should be such that it is unobtrusive in practice so that it too is not filtered out of digital communications like “spam” sent in email. Finally, such a system should give the buyer or consumer in real time while watching displayed broadcasts, a signal allowing them the chance to choose to receive a coupon being offered, thereby providing a much higher communication rate of a pushed advertisement, than the blind email communications of the past.

In this respect, before explaining at least one embodiment of the advertising encouragement and enablement system and method herein in detail, it is to be understood that the invention is not limited in its application to the details of construction and to the arrangement of the components set forth in the following description or illustrated in the drawings nor the steps and components outlined in the specification. The invention is capable of other embodiments and of being practiced and carried out in various ways as those skilled in the art will readily and immediately ascertain upon being educated by reading this application. Also, it is to be understood that the phraseology and terminology employed herein are for the purpose of description and should not be regarded as limiting.

As such, those skilled in the art will appreciate that the conception upon which this disclosure is based may readily be utilized as a basis for designing other methods and systems for carrying out the several purposes of the present invention which is a significant improvement to conventionally employed push advertising and viewer commercial watching encouragement. It is important, therefore, that the claims be regarded as including such equivalent construction insofar as they do not depart from the spirit and scope of the present invention.

### SUMMARY OF THE INVENTION

The coupon communication and distribution and viewer encouragement system herein described and disclosed, remedies the aforementioned shortfalls of current digital coupon and advertisement communications to viewers or buyers. It does so through the employment of a novel manner of communicating the presence of coupons or discounts, in real time, during media being viewed generally voluntarily by viewers who are also referred to as buyers herein. A particularly preferred mode of the system herein, provides user viewable signals or triggers which in real time provide the viewer with the knowledge that a coupon or discount is available if the commercial advertisement being played or to be played, is watched in its entirety. This real time signal encourages the viewer to watch the advertisement and not fast forward or skip through it as is being done on a regular basis conventionally.

In this patent application the term “coupon” will apply to any form of coupon (printed, electronic, stored, linked). Coupon will also apply to any form of application program, application program interacting with viewer, data being presented or received to/from subscriber, an offer of any kind, or voucher, or interactive or non-interactive data being displayed or conveyed to the subscriber.

A “coupon available” or “offer available” signals that is a coupon or offer or application or some other data is being presented to a viewer. Appropriate processing software running on microprocessors and networked communications for the type or form of coupon being provided is also included, and examples include the following:

Electronic coupon distribution with a relational database for storage of coupon delivered, providing a list of coupons available, providing export/import of coupon offers, tracking coupon redemption, modifying coupon values, geo-tracking where the geographic location is used to identify and signal a consumer where coupons can be applied, geographic offers where based on the location of a consumer coupon or offer values are provided or modified, etc.

Interactive coupon offers where an application such as a quiz related to a show or to an ad is communicated to the user and intended buyer. Appropriate interactive computer software and data processing and network communications is included in this patent application to process the application and perform database storage of data associated with the application and responses or offers received or earned by the subscriber or viewer.

Applications such as a ‘search’ or ‘recommend’ or ‘voting’ applications including application appropriate processing logic.

In this patent application the term ‘buyer’ ‘subscriber’ or ‘viewer’ or ‘individual’ or ‘person’ is used to indicate a person or group of persons viewing the content including ads, coupons, and optionally interactive applications. An example of a subscriber or viewer is a cable TV customer, a mobile phone customer, a consumer obtaining content or coupons over the open Internet, etc. A subscriber is also a person who receives a coupon and can redeem the coupon.

The term ‘client’ is used for any form of Set Top Box, mobile phone, Personal Computer (PC), game player, media player, TV, Internet or network connected TV, TIVO box, or Digital Video Recorder DVR device used to receive or display content.

Responses from client devices can be based on keypad or keyboard presses, or input of any type including verbal inputs which are software processed or otherwise communicated and understood to the sender over an appropriate network to servers using software adapted to the various communication tasks. Client can be any device or application receiving data such as a PC browser used to connect to a social media site. Any of the processing steps can be used to support any client device and client usage models.

In this patent application the term ‘content’ or ‘media’ is used to describe any form of network originated or electronic broadcast in the form of communicable digital data including but not limited to movies, videos, broadcast television, radio, music, games, text data, CD/DVD/Blu-ray discs, mobile data of any type, application programs, widget programs, widget data, formatted text or media data, compressed data in any form representing any content type. In addition, content also includes application related data such as social media data or content, social media chat data, and other forms of social media communications.

In this patent application the term ‘ad’ or advertisement, is used for any type of advertisement or even program content such as the audio and video associated with a TV show such as “Friends” or a movie Video On Demand title such as “Titanic”. Coupon distribution can be performed for an ad itself or coupon can be distributed without an actual ad. For example, a TV show such as “Friends” can have a coupon distributed without an ad being shown. In this example, while there is no ad itself, a coupon available signal indicator visually alerts the subscriber that a coupon can be obtained with an action by the viewer or user indicating a positive response which is communicated over the network.

The term coupon locker or coupon storage is used in this patent application to define any type of relational database system used to store coupon data including but not limited to the export of coupon data to a retail establishments loyal shopper rewards card or program. Coupon data on relational databases for subscribers who have met business rule requirements is exported to loyal shopper rewards program (or storage for coupon) with authentication data such as Private/Public key encrypted or signed data such that the coupon data is prevented from fraudulent transfers and fraudulent use. Coupon locker or storage can be on a client device such as a cell phone, or in an email account, or on a network, or on a cloud device communicating on the network, or any other data storage device associated with the coupon processing system or other system or device.

It is an object of this invention to provide real time discernable inducements to viewers of media having commercial advertisements, to watch the entire content of an advertisement.

It is another object of this invention to improve upon digital push-advertising through the employment of user input response to viewable signals, which indicate a viewer's desire to view and receive the coupon or discount offer.

It is yet another object of this invention to employ demographic information in relational databases concerning individual respective viewers, to send targeted coupon and discount offers to individual viewers which will particularly appeal to them specifically.

Yet an additional object of the invention to provide enhanced inducements to viewers to receive coupons and watch advertising by increasing the value of offers provided them in real time.

These together with other objects and advantages of the improved viewer encouragement and push advertising system herein become subsequently apparent to those skilled in the art, reside in the details of the construction and method herein as more fully hereinafter described and claimed, reference being had to the accompanying drawings forming a part thereof, wherein like numerals refer to like parts throughout.

### BRIEF DESCRIPTION OF THE FIGURES

FIG. 1 depicts a simplified mode of the system herein showing the coupon inducement system herein.

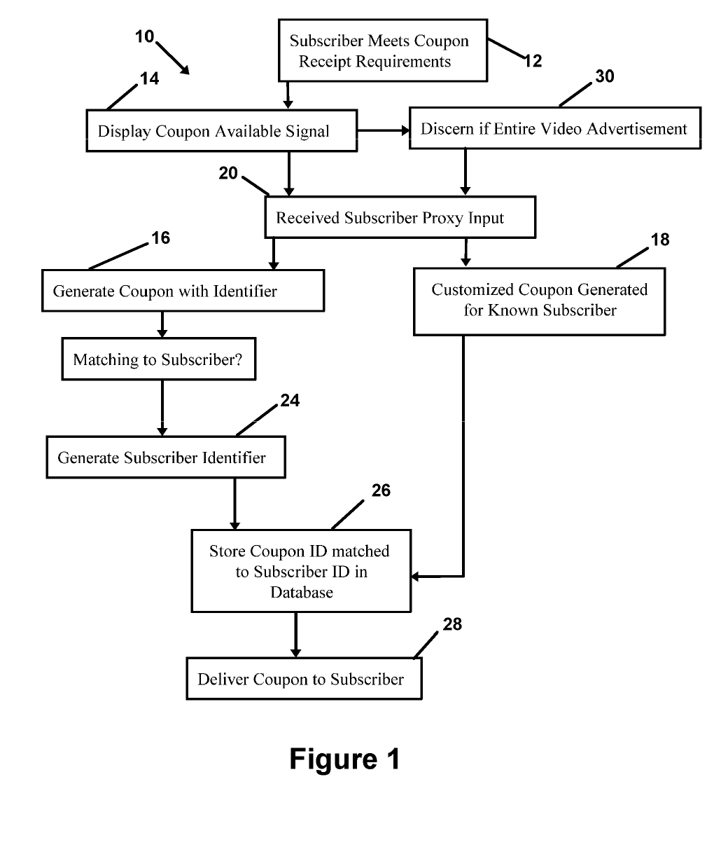

FIG. 2 depicts some optional features of the system of FIG. 1, wherein some, all, or none may be employed in concert with the system of FIG. 1.

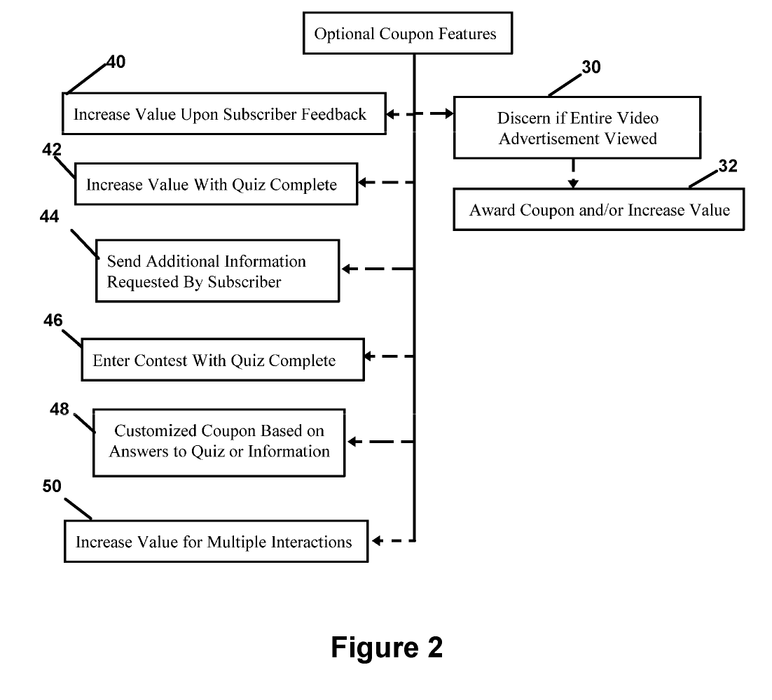

### DETAILED DESCRIPTION OF THE PREFERRED EMBODIMENTS OF THE INVENTION

One inventive element of system 10 herein disclosed, for subscribers or users who meet coupon receipt requirements 12 employs a signal 14 viewable by a user or viewer in real time, to add coupon or offer incentives to video or audio advertising with various business rules. These offered viewer incentives in the form of discounts or coupons 16 are associated with and employed in real time with traditional video or audio advertising viewed by viewers from original broadcasts, or viewer-recorded broadcasts played at a later time. The incentives such as the coupons 16 may also be customized 18 in targeted advertising such as the targeted advertising software developed and sold by Channel Islands, Inc. (www.channelislands.com).

The system 10 herein can be employed with any conventional digital broadcast system to add signals 14 concerning existing advertisements or shows, or to change the advertisements sent to individual and multiple viewers and also communicate the signal 14 that incentives are available to the opt-in viewer or user or subscriber, who inputs 20 a signal to the system 10 directly over a network or through a proxy server. Modern broadcasting provides exact timing of the broadcast of advertisements in virtually all broadcast and communicated commercial media which has advertisements. The system 10 herein employs the broadcaster provided information concerning the time of and length of advertisements, to communicate digital signals to insert in real time for the viewer, the signal 14 visually and/or audibly discernable by the viewer, that viewer inducements or coupons or incentives are available to the viewer who inputs 20 appropriately. The digital signals can be sent during the broadcast itself and inserted into the stream sent to viewers, or can be inserted in advance of the broadcast. In either case, viewers viewing the media at the first broadcast, or a subsequent playing of a recorded broadcast, will see in real time, during the viewing, the signal 14 concerning viewer inducements.

The system 10 employing software configured to the task of offering individual coupons 16 or incentives to networked viewers or users, and receiving and responding to user inputs 20 responding to signals 14 to the viewer in real time, operates using the software adapted therefor running on a networked computer or server. The software adapted to run the system will cause the transmission of data to individual viewers displaying the real time signal 14 and will perform the other data processing actions performed by any part of the system 10 and will also track user inputs 20, coupons 16, relational databases of coupons matched to users or subscribers 24, database storage of communicated coupons matched to users 26, and electronic communication of the coupon 28, all of which may be stored and can be employed for subsequent data analysis. The software enabled steps and actions described herein, can be distributed across one or more of the system processing elements such as broadcast receivers, recorders, and the like, with software running on appropriate data processors with appropriate networked communications.

### Coupon Registration/Ingest

Content appropriate ingest is performed where content is prepared for distribution on a distribution system or over a wide area network such as the internet or a large corporate or consumer network. Content ingest associates is a content identifier (ContentID) with content. Any form of content (TV show, movie, song, commercial, infomercial, etc.) can have an associated coupon. In some systems ContentID is applied by a different system than coupon distribution system and coupon distribution system uses existing ContentID not added by coupon processing. In other systems, a coupon processing related ContentID is added to the content and the existing ContentID is associated or linked to the ContentID added by coupon processing.

Coupon registration/ingest processing, as in all cases of operation of the system herein were communication, and/or relational data processing, and or other software enabled tasks are performed, employs software adapted to the task and running on an appropriate networked computing device, to relate and/or associate specific coupons 16 with ContentID of the program or advertisement being communicated to a user/viewer.

Coupon registration ingest associates a coupon with identifier 16 (CouponID) with coupon offer, coupon business rules, coupon image(s), coupon audio, coupon video, and other coupon related data including but not limited to product or service details, expiration date, special terms and conditions, and any other information. Any form of coupon with identifier 16 and other coupon data can be used including direct ID data inserted into video, audio, or separate from content or coupon video or audio.

It should be noted, that it is envisioned herein, that any form of coupon ingest can be used and one example is processed using software, relational databases, rules, and computer hardware adapted to the task, as follows:

Coupon Ingest:

a. Read coupon associated files including coupon offer description data, coupon video, coupon audio, coupon business rules, and other coupon related data.

b. Associate a coupon ID with the coupon being ingested. Coupon ID can be stored in coupon video or separate from coupon video. Coupon ID is associated with ContentID or a program or ad.

c. Associate coupon ID with one or more pieces of content or ads of any kind (motion video, graphics, pop-up, overlay, etc.).

d. Store coupon and coupon related data in database.

e. Ingested coupon and coupon related data will be output to playout server when coupon is being scheduled or played out (coupon sent to subscriber network or distribution network). Coupon distribution can be associated with an advertisement for the product or service associated with the coupon. Coupon distribution can also occur as part of an interactive coupon selection application where a subscriber can select coupons or play an interactive application (such as a game) to select coupons.

f. Coupon dispensing to subscriber can be stored in a central database or emailed to subscriber or a link provided to subscriber, or any other coupon distribution can be used. Coupon ID and offer data is associated with coupon dispensing to allow the coupon to be retrieved and used at a later time by the consumer. Any form of coupon dispensing and indicating or tracking coupon was dispensed, and then used by subscriber can be used.

### Content Distribution

Any form of content or application delivery is supported including VOD, Live TV, and interactive delivery of applications. In one example, a content distribution coupon available indicator or signal 14 is generated and communicated by software and hardware adapted to the task. The signal 14 is displayed in real time to viewing subscribers during watching of a live or recorded broadcast, to indicate that a coupon 16 being presented to the subscriber or viewer.

The system 10 optionally includes data to authenticate and data associated with the coupon 16, coupon offer, coupon distribution, coupon redemption, and can include or adapt the coupon to specific viewer related data or demographics for a known viewer or subscribe 18. The coupon can also include exchange related data (import or export) of any coupon data to other systems such as store loyalty programs, coupon lockers, etc.

### Coupon Available Viewable Signaling/Trigger

A Coupon Available signal 14 discernible by the subscriber or viewer, of any type may be added into ad content, or associated with an ad, or displayed just prior to the airing of an ad. This can be done by customizing the signal communicated to a viewer's display based on predetermined broadcaster timing for advertisements. In one example, the association of a coupon to an ad is performed by adding data using any form of data structure such as a data field indicating that a coupon is associated with the ad to the ad content itself, and this is called in-band. In-band association adds coupon data to the ad content itself. In out-of-band association a coupon is associated with an ad based on data not necessarily stored in the ad itself.

For example, the playout of an ad can be determined by an ad splicing server and the data used to control the splicer that indicates that a COKE ad should be spliced into the content stream, can be used to communicate a signal separate from the ad to a processing device that will be discernable by the subscriber to indicate to the subscriber that a coupon is available for this ad. A combination of in-band and out-of-band ‘coupon available’ and coupon related data can be used. Other examples of Coupon Available signaling include closed caption data, vertical blanking interval data, an audio or visual watermark, data in the content stream for a program (such as a TV show or VOD title), or data in the ad content stream. Coupon Available signaling 14 can optionally include a Coupon ID 16 in the Coupon Available signal 14 itself, or an association to an ad or content containing a coupon is performed using data external to the Coupon Available signal 14 or a combination of both can be used.

In this patent application the term ‘proxy’ is used to describe a processing element that interacts with the subscriber to manage the delivery of coupons to the customer, and inputs from the customer to the system 10. For VOD delivery to an STB the proxy receives VOD control messages from the STB such as ‘fast-forward’, ‘rewind’, ‘start’, ‘pause’, etc. and proxy includes logic to determine whether viewer qualifies for coupon.

In one example, advertisement video is associated with a coupon 16 offer and when it is discerned that the viewer does not skip the video ad 30 a coupon 16 is automatically communicated to the subscriber. In another example, when it is discerned the viewer does not skip video a coupon 16 is automatically provided to the subscriber, and the value of the coupon can be increased 32 by viewer pressing a remote control or other key associated with the coupon available subscriber-discernible indicator.

A device called a Proxy includes network specific processing to receive and process subscriber actions for input 20 and coupon delivery 28. In addition to receiving or monitoring client device actions proxy include programming logic to analyze input, perform processing and output data to client device (or other devices such as VOD server, or other devices). While the proxy is described as a stand alone device proxy can be distributed across one or more communicating electronic devices including but not limited to program logic in a Set Top Box (STB), or computer attached to a distribution network.

Examples of proxy inputs include but are not limited to remote control key presses on STB remote controls, media player inputs such as pause, rewind, etc. from PC player or mobile phone media player.

When Proxy is receiving media control signals such as content pause input, Proxy passes media control signal to device that would receive client media control signal if proxy did not intercept media control signal 20. In another example, proxy only monitors communications between client device and media device supplying content to subscriber.

While a Proxy server is used as on illustrative example other forms of program logic distribution and processing can be used including distributing any of the program elements in client devices and/or other network processing devices such as VOD servers, Ad splice (Terryon cherry picker type products), stand alone servers, broadcast streaming servers, on-demand servers, set top boxes (or other client devices), broadcast TV multiplexors, etc.

Example of Coupon Distribution Using a Proxy Server:

a. Subscriber is viewing program video (TV show, movie, etc. either on-demand or live TV).

b. Subscriber client device (STB, PC, mobile, etc.) control data such as channel up/down or channel selection or VOD fast-forward/rewind, etc. is sent from subscriber client device to system with client data being received by or available to proxy.

c. When appropriate (such as during VOD playout) proxy forwards client device control data to other devices such as VOD server. Proxy is aware of client device control data and uses client device control data in coupon processing.

d. During video (or audio/radio) playout of ad, the viewer discernable signal 14 or a wiggle (described below) is displayed visually or audibly or both. The signal or wiggle optionally indicates the presence of a coupon.

e. In one example, the business rules indicate a subscriber receives a coupon when subscriber does not fast-forward through a commercial. Other business rules will use different business logic and processing. In this example, subscriber did not fast-forward and subscriber is dispensed a coupon for the associated ad.

Proxy is aware of the ad, AD ID, business rules, and when business rules are satisfied dispenses a coupon. Proxy receives subscriber ID (ID of client device, or an ID associated with subscriber, subscriber network connection data, or other data used to associated distributed coupon to subscriber). Subscriber ID is associated with the issued coupon in a database (more details to follow), or subscriber receives a coupon associated with the ad. Distribution of coupon to client can be a printed coupon distribution (mailed to subscriber, or printed by subscriber), or coupon distribution can be electronic with coupon being available for download or storage by a client application, or stored in a subscribers coupon locker, or coupon is stored or indicated in subscribers coupon loyalty program database. Subscriber who has a client device for viewing content with coupons is linked to shopper loyalty database through any form of association including linking shopper loyalty ID with subscriber ID. Employing software running on data processing hardware with appropriate network connections, the coupon processing system exports subscriber coupon data to an import interface for a store shopper loyalty program, or a coupon locker for the subscriber. When stored in shopper loyalty program when subscriber is buying products and coupon for product exist in loyalty program coupon locker (or link to a coupon locker) then coupon is automatically applied to purchase.

f. In another example, when a subscriber enters a store the subscriber is informed of the items subscriber possesses coupons for at that store (either from coupon locker or another link to subscriber coupon data) and subscriber optionally receives addition locale information about the coupon and product such as the isle number or store location of the product.

g. In one example, coupon distribution is automatic, in another example subscriber selects receiving a coupon based on some action (presses a button, says ‘coupon’ or other word, etc.)

h. In this example proxy server performs necessary data processing to distribute or indicate coupon was delivered to subscriber. However, processing logic can be performed by any element in the system including the STB.

The actual coupon data after a coupon is issued to a subscriber can be sent using any physical (U.S. Postal Service, printed using a printer, etc.), or electronic networked digital distribution method including but not limited to the following:
a. Email, Short Message System (SMS) or Multimedia Message System (MMS) text or image message of coupon or coupon link.
b. Direct storage of coupon in a coupon application or coupon locker. Coupon application or coupon locker can be stored in a client device, or remotely. Remote storage can be in any device including a network device, a remote loyalty program coupon locker, network (or cloud based) storage device, etc.
c. Direct, indirect, or linked storage to phone number, or loyalty card, or credit card, or a coupon storage device with wired or wireless connection, or as images on a display device such as a mobile telephone or Ipad or laptop computer.

In this patent application coupon processing can incorporate one-dimensional or two-dimensional bar codes of any type as an identifier and for any processing including but not limited to representing coupon value and other coupon related data, representing (via bar code) the coupon valuation code optionally used to prevent coupon fraud, etc. One example is where the coupon data includes a unique identifier in the form of a validation code that is used to validate that the coupon is authentic and was delivered to the viewer 28 and this same code can be used to verify that the coupon was used only once by the advertiser subscribing to the service provided by the system 10 herein.

Coupon offers can be customized 18 to include expanded coupon promotions where subscriber or processing logic detects that the subscriber would like additional coupons and/or ads with and without coupons to be sent to the subscriber either as an on-demand like unicast of data to the subscriber, or via an SMS/MMS phone messages, or email, or as data sent to a player application with coupon support, or in another data format containing ads, or coupons, or content, or any combination of the these.

Content Coupon Available Visual Indicator/Animation

Ads with coupons 16 optionally include an image or animation or emoticon indicator or audible or other signal 14 that a coupon is associated with that specific ad and the indicator 14 (image, color change, logo, animation, video, emoticon, etc.) and is herein also referred to as a wiggle. In one example, the signal 14 or wiggle is a dollar sign (or money symbol) indicating that a coupon is available and wiggle is displayed on the screen of the media player (TV, phone, game player). Any image, video, animation, or audio prompt can be used for the wiggle. Wiggle animation and image merging of wiggle with content can be performed at any point in content distribution.

Any type of animation, image movement, image transformation, or sound or combination thereof, can be applied to electronically communicate the signal 14 in a wiggle image display. In this patent application the term wiggle is used for a signal 14 with and without animation.

Animation processing appropriate for the location of signal 14 display of the wiggle insertion is included. For example, when the wiggle is added in a Set Top Box then software in the STB uses the STB display video buffer processing logic to add an overlay or image onto the display screen. Likewise, when wiggle is added in an encoder the encoder will add the wiggle image (or animation) during the encode process.

In one example, the signal 14 or wiggle serves to indicate to the customer that a coupon 16 is available for this ad when it is discerned the viewer doesn't skip the ad 30 or change the channel. As such, the signal 14 or wiggle is used to indicate the presence of an offer which requires the subscriber conform to a distribution rule. In another example, the signal 14 or wiggle is used to indicate an offer where the value can increase 40 based on subscriber feedback or interaction.

Display of the signal 14 or wiggle processing can combine multiple images (image segments) when displaying coupon and/or wiggle image on display. In one example, a wiggle logo (one segment) is coupled with a logo or image of the product coupon or product company logo (second, third, etc.) segments combined and displayed on screen. For example, the wiggle logo character and animation is shown next to the advertising company logo, or an image of the product (example: Coke bottle), or another image related to the coupon, product, or company, or a combination. Wiggle insertion processing combines one or more images for display on screen overlaying a portion of the main ad or content. Wiggle processing optionally ads animation processing (movement, rotation, shaking, blowing up, fading in/out, shrinking/expanding, etc.) to one or more of the different image segments being combined. Data received by wiggle processing indicates the appropriate processing required for each segment being displayed on screen.

The signal 14 or wiggle optionally includes a timeout sensing software routine, where after no activity from the viewer on the client device is detected, then coupon 16 offers are no longer provided for this user or the individual client device. This timeout feature can be applied to broadcast TV, or recorded content or both. Time out optionally ads display indicator after time expires without some client action (no client interaction such as key press or channel change) that subscriber will need to provide feedback to receive additional coupons so that unattended TV viewing does not receive coupons. For example, after one hour without any TV remote control activity a signal 14 in the form of a wiggle question mark animated character can dance on the screen prompting the viewer to press any remote key to continue to receive offers. When coupon processing detects no client action or interaction from the client input 20 through the proxy or device, then automatic coupon distribution is suspended.

When client device has local or external (network storage such as network PVR or other device) content storage memory coupon offers can be stored in content storage and subscriber can access ads with coupons and select coupons. When coupon business rule indicates automatic distribution an client views stored ad with coupon offer than client automatically receives coupon. When subscriber accesses ads from memory and meets requirements of business rules then coupon offer is provided to subscriber. Coupon business rules can enable or disable coupon distribution from stored ad content (or any content) containing coupon offers.

The signal 14 or wiggle can be also electronically communicated or employed at any point during the content creation or content distribution processing including but not limited to adding the signal 14 or wiggle when the ad is created, adding the wiggle during content or ad distribution, during content or ad encoding or re-encoding, or during ad or content processing in the display device (set top box, television, mobile phone, etc.). The signal 14 can be digitally communicated so that the wiggle can be added as an image in the ad or content itself or as an overlay (blending two images together wherein both are visible) added to ad video or image or content video or image at any point in the ad/content distribution chain. In one example, the wiggle is added as a video overlay image onto the ad/content image(s) being displayed.

The signal 14 or wiggle animation or logo or image can have the look or feel or color scheme or audio or be based on one or more aspects of a product, service, show, or ad. For example, the signal 14 or wiggle for a Coke ad can be an animated COKE bottle image dancing in one corner of the client device display. Another example is where a coffee cup is shown with animated steam rising from the cup for a STARBUCKS coupon. In this example, the viewer or user view video of a coffee cup and can request through input 20 (or automatically receives) a coupon 16 for STARBUCKS.

The signal 14 to the viewer or wiggle can also have an audio indicator such as a bell chime to audibly alert a viewer that a coupon 16 is available, or, it the signal 14 comprising the wiggle may consist of only an audio indicator such as a tone or song. The signal 14 forming the wiggle indicator can be digital data added to content, digital data added to ad, digital data sent separate from content or ad. Or the signal 14 forming a wiggle can be in the form of data describing the wiggle coupon or offer, or a link to wiggle offer data, or an ID that is used to access the wiggle offer.

Optional data associated with wiggle processing by the system 10 includes data indicating the display duration of the wiggle image/animation, the location(s) on the screen, color, size, types of movement (up/down, shake, rotate, blow up into small pieces, etc.), interactive mode for prizes or additional coupon value, application information (if appropriate) for the wiggle image and wiggle related processing.

### Wiggle Stream Example:

1. Compressed video data (streaming or downloaded) for a show is sent across a digital network or distribution channel.

2. An optional conventional ad break indicator (such as SCTE-35 cue tone or other signal) is included in compressed video data to indicate an ad break. Additional data in the content stream or associated with the content stream or ad break indicates that a coupon is available.

3. Processing determines that an optional signal 14 in the form of a Wiggle Indicator (any form of data) is included in video data or separate from video data. Coupon processing accesses appropriate data depending upon how coupon data is sent (inband or out-of-band).

4. The communicated signal 14 with wiggle data includes a link to coupon or coupon data through user input 20.

5. In this example, STB processing display management software detects wiggle indicator and data and blends wiggle image with main image display (content or ad video and/or audio).

6. Depending upon business rules, coupon is delivered to subscriber.

7. When required by a coupon distributor, coupon delivery 28 and optionally a user or subscriber ID is reported back to coupon database 26 to match the recorded coupon. The coupon 16 as noted, optionally but preferably has a coupon tracking number and optional cryptographic MAC code as described in other sections of this patent application.

The coupon 16 or the signal 14 to produce the wiggle data can be sent during a show for associating an item on the show itself, with a coupon but without a commercial. A commercial-less offer shows the signal 14 or wiggle during a tv program or video (not an advertisement) and an offer is provided to the subscriber based on their input 20 and based on the business rules for the offer. The commercial-less offer includes the detection of coupon data without an ad and displays the wiggle or coupon-available indicator and processes the business rules associated with that offer. The coupon or wiggle available electronic communicated indicator for both commercial based and commercial-less coupon processing and triggering of subsequent processing can be sent in the program content itself, added to the content itself, inserted into the content stream, or sent out of band over a separate data channel from the program content.

The electronic communication or signal 14 viewable to show the wiggle can optionally be sent separate from commercial ad containing ad audio and video, or can be sent using data indicating that a signal 14 or wiggle is present including details (offer data, or link to offer data, or offer ID, etc.).

The signal 14 or wiggle can be displayed during ad associated with coupon or at a time prior to the ad as a ‘teaser’ that a coupon is coming soon. Various shapes, images, and sizes of wiggles can be displayed, being statically displayed or moving across the screen or fading in and fading out on the screen and any other form of motion, display, animation, color change, size/position changing, etc.

### Coupon Targeting

Advertisers can optionally customize the coupon 18 or target coupon offers to selected groups of viewers using any form of targeting including but not limited to geographic, interest based (people who like to bowl), income based, age, user demographic data from third parties such as rewards card programs, or any other targeting method. Coupon offers identified by a signal 14 and accepted by user with an input 20 can vary based on the targeted subscribers which an advertiser desires to reach. Processing common to the targeted advertising is optionally applied for coupon targeting.

An example targeted advertising system is the Diva system offered by Channel Islands Media Group (www.channelislands.com). Diva's targeted ad subscriber profile processing is optionally applied to the coupon distribution described herein adding sophisticated targeting capabilities to coupon distribution. When coupled with targeted ad distribution system a coupon is distributed to subscriber using the same or similar subscriber targeting as targeted ad distribution.

### Coupon Preview and Coupon Program Guide (CPG)

The system 10 herein can include and optional preview of upcoming coupons displayed in a fashion similar to how subscriber can preview upcoming TV shows. The system 10 will build a list of upcoming ads with coupons 16 and build a coupon preview list that can be viewed by subscriber with any type of formatting. In one example a Coupon Preview uses a grid guide similar to an Electronic Program Guide (EPG). In another example, subscriber can search CPG for coupons subscriber is interested in obtaining. CPG provides an advanced display of upcoming coupons informing a subscriber about upcoming coupon offers.

In another example a normal EPG is presented with and without coupon preview logos that indicate the show has coupons and coupon preview logo can indicate special value, or super value, or contain a logo associated with the commercials in the show. In this example the EPG shows upcoming ads with coupons so viewers will know before the show airs that coupon are associated with ads in the programs.

The system 10 ingests ads associated with TV programs (or any content), searches for coupons associated with the TV program ad and builds a coupon program schedule that viewer can view on any device. In one example coupon program schedule is shown on client device in the format of an EPG containing icons or logos for the coupons that will be available during a show. CPG is sent to, or available from client device. In addition, subscriber can set product or coupon favorites to be alerted when coupons matching their favorites will be available.

### Business Rules

Coupon dispensing or delivery 28, where the viewer qualifies for coupon 12, and usage can use any combination of non-interactive or interactive processing business rules in conjunction with software running on hardware adapted to the task of such delivery according to rules based software. Software employing the business rules define what steps need to occur to qualify a user or subscriber as meeting requirements 12 and provide one or more incentives/coupons to a subscriber. Example business rules include but are not limited to the following:

a. Automatic coupon dispensed without having to do anything.

b. Manual where subscriber provides proper input 20 to the system 10 or through a proxy, by for instance pressing a button on the remote control or entering a provided code such as “enter 333” on your iPhone application or coupon application. When consumer inputs 20 by entering the code on their client device (not necessarily the one they are viewing ad/coupon offer on), subscriber input 20 response is sent to coupon system 10 and the phone number of the subscriber (or IP address or subscriber registration data) is used to distribute coupon to subscriber based on subscriber response.

As mentioned, a subscriber can see the coupon offer on one device and response on another. The appropriate gateway processing is envisioned to receive consumer response to offer and dispense coupon to subscriber. In one example, coupon offer says text “333” to COKE (number is stored in coupon application on phone) and a SMS text message containing the code “333” is sent to the coupon gateway. Coupon gateway receives “333” message and subscribers phone number and dispenses coupon (in any format) to subscriber in any manner (email, printed, MMS or SMS text, to a coupon locker, to the phone application (if any)).

c. The coupon may be automatically dispensed with coupon sent to another system such as a stores shoppers loyalty card program.

d. Or optionally the coupon may be dispensed 32 when the entire commercial is viewed 30 without fast-forwarding or changing channels during the commercial.

e. Optionally, an increased coupon value based on interactive feedback 40 from subscriber about the ad. Examples include but are not limited to the following:

a1. Pressing a button during the playout that indicates you would like more information or a higher value coupon.

b1. Taking a ‘quiz’ to win a higher value coupon.

c1. Being entered for a prize or lottery based on some action or feedback after seeing an ad.

d. The coupon may be customized subsequent to an input 20 response to prompting for other products the subscriber may be interested in and additional information may be sent 44. Response can be direct from the subscriber using a remote control or input on the client device, or indirect from CRM data or determined based on profile collection data based on subscriber viewing habits or geographical location or other subscriber profile data obtained from any source.

f. Also, where more interactions from a subscriber are received, an increase in incentive value provided for the coupon 42 may be provided.

g. Also optionally, special promotions where feedback of any sort (button press on remote, using a coupon, receiving a coupon, etc.) qualifies for the subscriber being entered into a lottery for special awards or prizes 46.

h. Multiple button interaction where you get a bigger coupon by pressing say ‘5’ during the ad because text in the ad indicated that ‘5’ is the special bonus number.

i. Targeted coupon deliver.

j. Targeted ad delivery with coupon.

k. Bartered where consumers are allowed to swapped for other coupons. In one example, subscriber can barter coupons to another subscriber and advertiser can collect subscriber coupon transfer data in addition to all the other data advertiser or content distributor collects regarding subscriber viewing habits, ad viewing habits, coupon selection data, coupon redemption data, etc. Bartering value of coupons can be based on any number of coupon related data with examples including coupon value, expiration date, bonus values, coupon can be bartered or shared at one particular supermarket chain, barter or sharing allowed only to supermarket chain loyalty program customers, etc.

l. Shared coupons can work similar to bartered coupons without the bartering processing and with the coupon simply being shared. Shared coupon can have any business rules associated with the coupon including “can be shared only if redeemed in 48 hours”, etc.

An optional mode is an interactive quiz mode 48 where coupon value increases based on subscriber providing interactive feedback. For example, a bonus coupon can be offered if the subscriber answers an ad related question such as “How many dogs were in the dog food ad” that was just aired. Get the question right and the coupon value is increased, or receive some other award such as being entered into a lottery.

Another form of interactive coupon distribution uses what is called the “red button” of interactive TV. The red button is used to describe feedback of any form from the subscriber. Subscriber feedback can indicate that a subscriber likes or dislikes a product or offer, or would like more information or is used to provide feedback of any kind. When a subscriber provided feedback data associated with a coupon can be modified to change offer values or offer dates or other aspects of the coupon. In one example, the more you interact the larger the coupon value.

In another example, all users providing feedback are entered into a lottery. In yet another example, the first thirty viewers to provide feedback obtain a higher priced ad. In this way, viewer are invited to pay more attention to commercials or coupon offers (with or without ads) because of the increased coupon value 50 based on subscriber feedback or actions taken by a subscriber.

There are an unlimited number of optional features which are employable with business rules that can be associated with an offer and coupon distribution/processing. This invention should not be limited by the examples provided above, rather it is envisioned that new business rules for coupon distribution will evolve based on inventive elements contained herein.

Coupon distribution can be limited using any rules such as this coupon is only available to the first fifty subscribers to select the ad. Ad distribution processing counts the number of coupons distributed and stops distribution after the criteria (e.g. first 50 to request the coupon) is met. Coupon Program Guide discussed above or coupon available indicator optionally indicates a limited coupon offer.

Dynamic Coupons—where Value Changes

Just like the optional motion associated with the signal 14 formed by the wiggle, coupon values can change dynamically based on any rules or logic. Coupon values can increase or decrease based on time or date, or store where item is bought, or combination of items being purchased (buy 3 PROCTER & GAMBLE products and receive 4th free), etc. Campaign manager coordinates dynamic values of coupons.

### Database

The system 10 includes one or a plurality of relational databases of any software appropriate format to store coupon offers related with offer details (expiration date, value, redeem at, etc.) along with in one example, providing a coupon locker for storing the a subscribers coupons, and in another example for interfacing subscribers coupons to a retailers or companies loyalty program (such as a supermarket loyalty program card) for storing coupon information either in this system or any other external system. Coupon storage can use actual coupon data (image, data, optional transactional ID to validate coupon) or storage can be based on a link or association of the coupon with the subscriber.

Any or all data associated with content, ad, ad viewing, coupon distribution, redemption, processing, fulfillment, etc. is tracked in database or another storage device such as the a client device or other storage device. Database can connect to other systems or databases of any kind.

Many different forms of coupon distribution are included in this system 10 including digitally communicating and importing or exporting coupon data to other systems including but not limited to coupon lockers where a subscribers coupons are stored, loyalty programs where coupons are sent to a retail establishments loyalty program processing, coupon storage where a subscriber can interact with coupon related data or offers such as deleting coupons. Coupon import or export processing using software and hardware adapted to the task, allows the transfer of data between disparate systems such as a retail loyalty program and this system.

### Coupon Applications

The disclosed system 10 herein includes coupon applications employing software running on appropriate networked and communicating hardware all adapted to the task of managing and the storage and usage of the coupons herein including but not limited to the following processing:

a. Reporting coupons expiration dates to subscriber with optional warnings when a coupon expiration date is near.

b. Automatically shopping a number of stores to find the store with the best price for the product that the subscriber has a coupon for, or automatic shopping with and without coupon items the subscriber is shopping for.

c. Arranging coupons in order of value.

d. Year to date total coupon savings with one or more subcategories of reporting (clothing YTD savings, grocery YTD savings, YTD savings at a particular store, total value of loyalty rewards, etc.)

e. Price of last purchase of similar item.

f. Viewing coupon locker.

g. In one example of GPS application support, system 10 determines location of subscriber and indicates which coupons can be used at stores within a the subscribers current geographic area. In another example, the subscriber puts in the location of a store (ABC store in San Diego, Calif.), and application processing indicates the coupons that can be used at that store and optionally the product price for the item having a coupon. System 10 can query coupon locker and using GPS can indicate to subscriber a number of stores carrying the product with associated coupon, and optionally price comparison shopping as well.

h. System 10 can dynamically alter coupon values and optionally send alerts to customer. In one example,

i. If allowed by the company offering the coupon, coupon forwarding or coupon sharing.

j. A viewer for coupon, or coupon/coupon locker, or a sorting program to capture coupons from email, SMS/MMS messages, or other coupon distribution method.

k. A ‘find me’ service to find the product associated with a coupon at the nearest location.

l. A ‘best price’ sort that sorts the coupons based on product pricing at two or more stores. For example, the product associated with the COKE coupon is $1.39 at store A and $1.89 at store B. System 10 can indicate the cost savings of one location versus a second location.

m. Cross platform promotions between advertisers and studios, redeem 20 coupons get a movie credit (coupon chaining linking a products coupon distribution, pampers coupon linking to another ad/coupon or content, or buy pampers and get a stroller incentive).

n. A display of the coupon offer on a display such as a mobile phone display allowing the coupon to be scanned during checkout or by a scanning device.

o. Activating coupon applications when a coupon or content with coupon is detected.

In one example, subscriber can access their coupon locker or coupon storage to view what coupon offers the subscriber has. In another example, coupon locker is accessed by an software routine that reports to subscriber the coupons they have available at various times or for various application processing.

The coupon processing system includes software and computer hardware providing application processing support for software applications running on computers which interact with the coupon database. System 10 processing manages and displays coupon data to the subscriber along with other data and processing as exemplified in the above examples.

There are many modes for coupons which can be developed for coupon selection, automatic or interactive coupon selection and delivery, interactive coupon applications where values or offers vary based on interactivity, coupon related games and quizzes, coupon sharing and bartering where coupon business rules allow, timed specials (example: double coupon value for the next 24 hours, etc.).

### Coupon Redemption

Coupon distribution is supported in a number of ways, and likewise, coupon redemption is supported in a number of ways. In one example, subscriber coupon data is exported to another coupon delivery or redemption system with appropriate security measures to prevent coupon fraud. In another example, a coupon image on a client device is scanned during coupon redemption. In another example, a printed coupon is used and turned in by the subscriber during checkout. Coupon redemption can occur based on the subscriber having a coupon (physical or electronic). Coupon redemption can also validate the proper issuance of the coupon by checking a coupon delivery database that stores the subscriber ID and coupon data allowing the redemption process to interrogate the coupon database to validate proper coupon distribution.

In one example, coupon redemption process includes transferring data about coupons and other data such as program or shows watched, ads seen, coupons received, date and time information about content or ads or coupons or redemption, or other data to coupon process system. This data can be used by content provider, advertiser, coupon processor, store, or sold to other parties.

### Coupon Tracking and Validation

There is a wide range of coupon values ranging from a few cents off a product to much larger values that can include prize values and other high values. Using software adapted to the task and running on communicating and networked computers, an optional coupon tracking and validation system of this invention adds a tracking code to a coupon where the tracking code is used to track distribution, validate the offer, and record the use of the coupon. When distributing millions of low value coupons a tracking code may not be warranted. The tracking code is associated with a coupon ID and depending upon type of coupon distributed a subscriber delivery code. An example data field for coupon tracking and validation is shown below:

Coupon ID: An Identifier for this Coupon.

Coupon Tracking Number: an alpha numeric identifier or number or other unique discernable identifier may be used to track this instance of the coupon. Coupon tracking number can be unique for each instance or copy of the coupon delivered to a subscriber. In one example coupon tracking number is an incrementing number for each coupon delivered. Any form of tracking code can be applied. In one example the unique tracking codes includes a coupon/message authentication code (MAC) that is used to authenticate the coupon for tracking purposes optionally linking the coupon to the delivery and a subscriber. Any form of cryptographic Message Authentication Code or similar can be used to validate the coupon tracking code. For example, a digital signature can be applied to one or more of the coupon tracking codes when the coupon is distributed and the distributed coupon is linked to the subscriber or distribution. During coupon redemption the MAC code derived from the coupon tracking code information is validated to make sure it is authentic. When coupon distribution is tracked to an individual then the subscriber specific authentication of the coupon can also be performed.

The following high level steps describe the coupon dispensing portion of the coupon distribution process:

a. Determining that a subscriber meets the requirements for the distribution of a coupon.

b. Generating a coupon that has a coupon tracking number, an optional ad id, optional coupon related data such as coupon value and expiration date, an optional subscriber ID when coupon delivery is tracked to an individual, and a MAC code on one or more of the described coupon data fields (tracking number, ad id, coupon related data, etc.).

c. When individual coupons are tracked, storing the coupon data and subscriber ID in a database.

d. Using the coupon generated in step b above, delivering the coupon to the subscriber or storing it in a storage device (coupon locker, application memory, loyalty program, etc.) associated with the subscriber.

Coupon redemption indicator: indicates in the coupon database that the coupon delivered with a particular tracking number was redeemed.

Optional ad ID: an optional identifier that indicates the ad that was associated with this coupon or the ad id that should be associated with this offer.

### Campaign Manager

A campaign manager processor coordinates the coupon campaigns, generates data associated with the ad and coupon business rules, and includes a number of standard items found in ad managers with coupon extensions. It is envisioned that one skilled in the art of electronic coupon distribution will define the appropriate campaign manager to manage the various distribution models and business rules described in the disclosed system 10 herein. In addition to normal ad campaign processing there are coupon related campaign management features including but not limited to the following:
A—Campaign Name
B—VOD/Broadcast or Both
C—Ad budget
D—Maximum CPM for this budget
E—Maximum number of spots.
F—Impressions already delivered.
G—Start date of Campaign
H—End data of Campaign
I—How ad is placed, priority, round robin, etc.
J—One or more ads associated with this campaign.
K—Ad name
L—Ad duration in seconds
M—Start time ad can be viewed
N—End time ad can be viewed
O—Maximum number of ads in any one ad break.
P—Maximum number of ads in one VOD title.
Q—Campaign Profiles
R—Target can be genre of content plus profile data
S—Defines genre list
T—Campaign asset resource
U—Cross platform campaign
V—Dynamic ad value and rules or logic
W—Wiggle, size, location, animation, color, increase/decrease in size, rotation,
X—Coupon value, expiration date/time, multiple coupons allowed, can be bartered, can be shared, track coupon distribution and redemption, include coupon digital MAC authentication, allow GPS tracking, allow lowest price shopping, etc.
Y—Special data such as valid at certain retailer, on special days of the week, etc.
Z—Interactive coupon application available, application name, location, etc.

### One-Way, Non-Interactive, Two-Way Distribution

In another example of this invention, employing software adapted to the task and running on communicating and/or networked computer and communication hardware, one-way, two way interactive and two-way non-interactive networks are supported with coupon distribution and fraud prevention. Coupon data (on one-way or two-way network) includes the following:

a. Subscriber ID or client ID

b. Coupon ID and/or coupon data

c. Cryptographic binding hash of one or more coupon or subscriber data values in any combination. Coupon or subscriber data values include but are not limited to subscriber ID, coupon ID, client device ID, a network supplied data value, or other data. Purpose of cryptographic binding hash is to bind the coupon delivery to a subscriber such that the subscriber cannot share coupons with other subscribers. And, that the coupon delivery to a subscriber can be validated during redemption or at any other time. In addition, on one way networks coupon redemption processing tracks coupon delivery to subscriber.

d. Above cryptographic hash can be validated in any number of ways. One example is that the cryptographic binding hash includes a digital signature of one or more data values singed with the private key of the client device and authenticated by other devices using the client devices public key. There are many other ways to achieve binding hash processing and validation that one skilled in the art of cryptographic design can utilize.

e. Cryptographic binding hash data in one example is validated using subscriber ID and loyalty program data. In another example, subscriber ID, loyalty program data and cryptographic hash generated when coupon is dispensed is used to validate coupon and prevent coupon fraud. In yet another example, subscriber ID, loyalty program data, cryptographic hash, and a time stamp of delivery is validated with processing using cryptographic hash.

While all of the fundamental characteristics and features of the coupon distribution system invention herein have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions, as would occur to those skilled in the art upon a review of this patent, are considered included within the scope of the invention as defined by the following claims.

What is claimed is:

1. A coupon distribution system, employing software running on a computer configured for generating and communicating user incentives such as coupons, to user media playing devices over a network, comprising:
communicating an electronic signal to a media device, said signal positioning a discernable indicator depicted upon a display screen of said media device indicating an incentive available to a user viewing media depicted upon said display screen;
providing a user activated input, said input allowing said user to communicate an input signal through said media device of an acceptance of said incentive;
ascertaining if a said user communicates a said input signal subsequent to a display of said discernable indicator on said video display;
communicating said incentive to said user over said network, said incentive being for a discount employable by said user for a product or service of an advertiser; and
allowing said user to employ said incentive for a said discount with said advertiser.

2. The coupon distribution system of claim 1, additionally comprising:
including in said discernable indicator, instructions to said user, said incentive is only receivable subsequent to a complete viewing by said user, of an advertisement depicted on said media device, over a time duration subsequent to a depiction of said discernable indicator on said display;
monitoring said media player of said user for a determination said advertisement was depicted on said media device for said time duration; and
subsequent to a said determination said advertisement was depicted for said time duration, communicating said incentive to said user over said network, whereby said users are encouraged to watch said advertisement in real time and avoid a skipping thereof.

3. The coupon distribution system of claim 1, additionally comprising:
ascertaining an identification of said user from a database of a plurality of said users;
employing database of ascertained interests of said user to determine a said incentive related to one of said interests of said user; and
communicating said incentive related to one of said interests of said user to said user over said network.

4. The coupon distribution system of claim 2, additionally comprising:
ascertaining an identification of said user from a database of a plurality of said users;
employing database of ascertained interests of said user to determine a said incentive related to one of said interests of said user; and
communicating said incentive related to one of said interests of said user, to said user over said network.

5. The coupon distribution system of claim 1, additionally comprising:
assigning a unique identifier to each said incentive communicated to each said user;
maintaining a relational database of each respective user and the identifier of incentives communicated thereto;
employing said relational database to discern said products and services of related interest to said user which relate to said incentives previously sent to each said user; and
in future communications with respective said users, indicating said incentive available to a respective said user is one of said products and services of related interest.

6. The coupon distribution system of claim 2, additionally comprising:
assigning a unique identifier to each said incentive communicated to each said user;
maintaining a relational database of each respective user and the identifier of incentives communicated thereto;
employing said relational database to discern said products and services of related interest to said user which relate to said incentives previously sent to each said user; and
in future communications with respective said users, indicating said incentive available to a respective said user is one of said products and services.

7. The coupon distribution system of claim 3, additionally comprising:
assigning a unique identifier to each said incentive communicated to each said user;
maintaining a relational database of each respective user and the identifier of incentives communicated thereto;
employing said relational database to discern said products and services of related interest to said user which relate to said incentives previously sent to each said user; and
in future communications with respective said users, indicating said incentive available to a respective said user is one of said products and services.

8. The coupon distribution system of claim 1, additionally comprising:
communicating to said user an enhancement of a value of said incentive after an elapsed time duration;
ascertaining if said input signal is communicated from said signal, subsequent to said elapsed time duration; and
increasing said incentive by said enhancement of value prior to communicating said incentive to said user over said network.

9. The coupon distribution system of claim 2, additionally comprising:
communicating to said user an enhancement of a value of said incentive after an elapsed time duration;
ascertaining if said input signal is communicated from said signal, subsequent to said elapsed time duration; and
increasing said incentive by said enhancement of value prior to communicating said incentive to said user over said network.

10. The coupon distribution system of claim 3, additionally comprising:
communicating to said user an enhancement of a value of said incentive after an elapsed time duration;
ascertaining if said input signal is communicated from said signal, subsequent to said elapsed time duration; and
increasing said incentive by said enhancement of value prior to communicating said incentive to said user over said network.

11. The coupon distribution system of claim 4, additionally comprising:
communicating to said user an enhancement of a value of said incentive after an elapsed time duration;
ascertaining if said input signal is communicated from said signal, subsequent to said elapsed time duration; and
increasing said incentive by said enhancement of value prior to communicating said incentive to said user over said network.

12. The coupon distribution system of claim 5, additionally comprising:
communicating to said user an enhancement of a value of said incentive after an elapsed time duration;
ascertaining if said input signal is communicated from said signal, subsequent to said elapsed time duration; and
increasing said incentive by said enhancement of value prior to communicating said incentive to said user over said network.

13. The coupon distribution system of claim 6, additionally comprising:
communicating to said user an enhancement of a value of said incentive after an elapsed time duration;
ascertaining if said input signal is communicated from said signal, subsequent to said elapsed time duration; and
increasing said incentive by said enhancement of value prior to communicating said incentive to said user over said network.

14. The coupon distribution system of claim 7, additionally comprising:
communicating to said user an enhancement of a value of said incentive after an elapsed time duration;
ascertaining if said input signal is communicated from said signal, subsequent to said elapsed time duration; and
increasing said incentive by said enhancement of value prior to communicating said incentive to said user over said network.

15. The coupon distribution system of claim 8, additionally comprising:
communicating to said user an enhancement of a value of said incentive after an elapsed time duration;
ascertaining if said input signal is communicated from said signal, subsequent to said elapsed time duration; and
increasing said incentive by said enhancement of value prior to communicating said incentive to said user over said network.

16. The coupon distribution system of claim 1, additionally comprising:
said discernable indicator being animated.

17. The coupon distribution system of claim 2, additionally comprising:
said discernable indicator being animated.
